(19) United States
(12) Patent Application Publication
(10) Pub. No.: US 2013/0230294 A1
(43) Pub. Date: Sep. 5, 2013

(54) IMAGE MONITORING SYSTEM AND CAMERA

(71) Applicants: Atsushi Sassa, Kodaira (JP); Akinori Kouchi, Kodaira (JP); Tomohiro Aikawa, Kodaira (JP); Masaru Fujii, Kodaira (JP); Kei Takahashi, Kodaira (JP); Masashi Hohya, Kodaira (JP); Akira Yoshizumi, Kodaira (JP); Takayuki Koizumi, Kodaira (JP)

(72) Inventors: Atsushi Sassa, Kodaira (JP); Akinori Kouchi, Kodaira (JP); Tomohiro Aikawa, Kodaira (JP); Masaru Fujii, Kodaira (JP); Kei Takahashi, Kodaira (JP); Masashi Hohya, Kodaira (JP); Akira Yoshizumi, Kodaira (JP); Takayuki Koizumi, Kodaira (JP)

(73) Assignee: HITACHI KOKUSAI ELECTRIC INC., Tokyo (JP)

(21) Appl. No.: 13/817,353

(22) PCT Filed: Aug. 19, 2011
(86) PCT No.: PCT/JP2011/068759

§ 371 Date: Mar. 21, 2013

(30) Foreign Application Priority Data
Aug. 20, 2010 (JP) 2010-184943

(51) Int. Cl. H04N 7/18

(52) U.S. Cl. CPC H04N 7/18
USPC 386/224

(57) ABSTRACT

The purpose of the present invention is to provide an image monitoring system which can be used in a place where a network cannot be established and has excellent portability. When an image is captured during the daytime or in a bright place, a camera (10) is equipped with a near-infrared cut filter, captures an image of a subject, and outputs a color image. On the other hand, when an image is captured during the nighttime or in a dark place, the near-infrared cut filter is removed from the camera (10), an LED light (11) irradiates the subject with near-infrared light in synchronization with the shutter speed of the camera (10), and the camera (10) captures an image of the near-infrared light reflected by the subject and outputs a monochrome image. The image outputted from the camera (10) is inputted to a recording device via a dedicated cable.

### TECHNICAL FIELD

The present invention relates to a portable image monitoring system which captures and records images with a camera and a recording device carried to and installed at a desired place.

### BACKGROUND ART

The image monitoring system is installed in various public facilities such as hotels, buildings, convenience stores financial institutions, dams, on roads and others for purposes, such as crime prevention, follow-up verification, accident prevention and the like. A conventional general image monitoring system captures an image of a monitored area by a camera or the like, sends the captured image to a monitoring center such as an administration office, a security office or the like, where an attendant monitors the monitored subject referring to the image transmitted, gives cautions or warnings depending on a purpose or necessity, and records and stores the image. A network type image monitoring system which monitors by digitizing the image in the monitoring camera and sending the image through a network represented by the Internet is increasingly spreading in recent years. A conventional network type image monitoring system is described below.

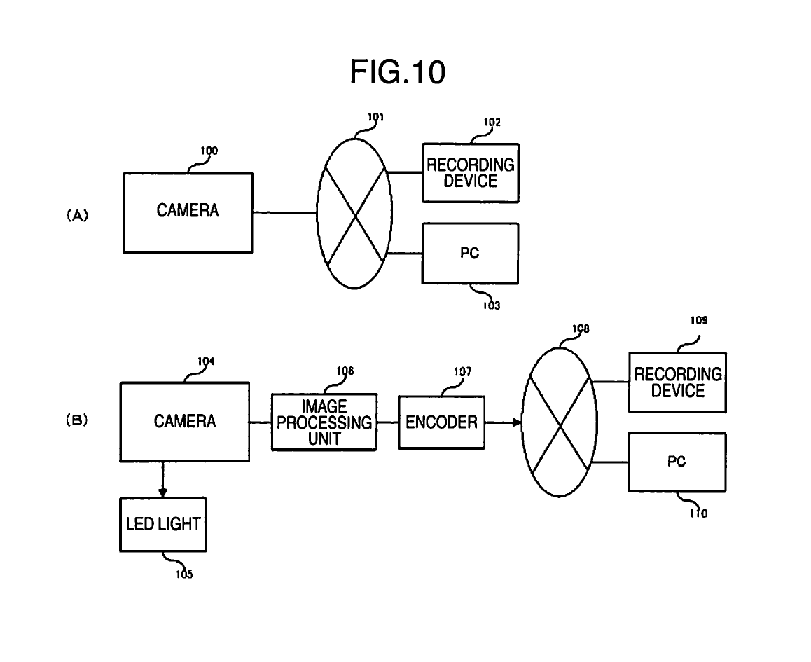

FIG. 10(A) is a block diagram of a conventional network image monitoring system. 100 is an IP camera which outputs the captured image to the network, 101 is a network such as the Internet, 102 is an image recording device for recording an image captured by the IP camera 100, 103 is a PC which controls the camera 100 and the recording device 102 and is used to view images.

The IP camera 100 captures an image of a subject and outputs the image to the network 101. The outputted image is inputted to the image recording device 102 and the PC 103, the image recording device 102 records the image, and the PC 103 displays the image.

There is also a common image monitoring system which uses a camera as a color camera to capture a color image when the image is captured during the daytime or in a bright place and as a near-infrared camera to capture a monochrome image when the image is captured during the nighttime or in a dark place, so that a monitored image is obtained regardless of whether it is day, night, bright or dark. The conventional image monitoring system which does not make a distinction among day, night, bright and dark will be described below.

FIG. 10(B) is a block diagram of the conventional image monitoring system which does not make a distinction among day, night, bright and dark. 104 is a day/night camera which captures a color image and a monochrome image with a near-infrared cut filter attached or removed, 105 is an LED light which emits near-infrared light, 106 is an image processing unit which performs predetermined image processing on the image captured by the day/night camera, 107 is an encoder which converts the image after the image processing into a signal suitable to the network and outputs, 108 is a network such as the Internet, 109 is an image recording device for recording the image captured by the day/night camera 104, and 110 is a PC which controls the day/night camera 104 and the recording device 109 and is used to view the images.

The day/night camera 104, when it is used as a color camera, has a near-infrared cut filter to cut an infrared ray to capture an image of incident light of a visible light region with the infrared ray cut off from the incident light. It is because many image-capturing parts have a sensitivity in a visible light region and a near-infrared ray region and cannot obtain a normal color image when it captures images of visible light and near-infrared light at the same time.

When it is used as the near-infrared camera, the near-infrared cut filter is removed, and an image of incident light in the infrared ray region is captured. When the camera is used as the near-infrared camera, the LED light 105 for emitting near-infrared light is occasionally used in view of a sensitivity and lighting.

When an image is captured during the daytime or in a bright place, the day/night camera 104 captures an image of a subject with the near-infrared cut filter attached and outputs a color image. On the other hand, when an image is captured during the nighttime or in a dark place, the near-infrared cut filter is removed from the day/night camera 104, the LED light 105 emits light in synchronization with the shutter speed of the day/night camera 104, and the day/night camera 104 captures an image of the subject and outputs a monochrome image. The image outputted from the day/night camera 104 is subject to a predetermined image processing by the image processing unit 106, converted by the encoder 107 to a signal form suitable for the network and outputted to the network. The outputted image is inputted to the image recording device 102 and the PC 103, the image is recorded by the image recording device 102, and the image is displayed by the PC 103.

There is disclosed a network image monitoring system that sends the image captured by the camera through the network, records by the recording device and displays by the display device (see PATENT LITERATURE 1).

There is also disclosed a technology that has a camera which is used as a color camera to capture a color image when capturing during the daytime or in a bright place and used as a monochrome near-infrared camera to capture a monochrome image by using a near-infrared ray irradiation part when capturing during the nighttime or in a dark place, and a white light-emitting part installed near the near-infrared ray irradiation part to make red light emission less noticeable (see PATENT LITERATURE 2).

### CITATION LIST

### Patent Literature

PATENT LITERATURE 1: JP-A-2009-100208

PATENT LITERATURE 2: JP-A-2005-049719

### SUMMARY OF INVENTION

### Technical Problem

The above-described image monitoring system generally establishes a network, allocates an IP address to an IP device, installs the camera and the recording device at a stationary place, and has a disadvantage that it can not be used in a place where a network cannot be established. When it is desired to use with the install place changed frequently, a large load is applied to removal, transportation and install of the devices.

The present invention has been achieved to solve the above-described problems and aims to provide an image monitoring system which can be used in a place where a network cannot be established and has excellent portability.

### Solution to Problem

An image monitoring system of the present invention comprises a camera which is provided with an image-capturing part for capturing an image of a subject and outputting the image, an encrypting part for encoding the image and a control part for controlling the image-capturing part and the encrypting part, and a recording device which is provided with a detachable recording medium for recording the image captured by the camera and a control part for controlling the recording medium, wherein the camera and the recording device are connected via a cable.

The above image monitoring system is characterized in that the obtained images are encoded by means of a secret key in the encrypting part of the camera, and the recording device records a single file that plural images were unified.

A camera of the present invention comprises an image-capturing part for capturing an image of a subject and outputting the image, a filter part for attaching/removing an infrared ray cut filter, an emitting part which has a plurality of light emitters and emits near-infrared light, and a control part for controlling the image-capturing part, the filter part and the emitting part, wherein the control part controls to obtain an image with the infrared ray cut filter removed when it is bright, and controls to insert the infrared ray cut filter when it is dark and to make the emitting part emit in synchronization with the shutter timing of the image-capturing part.

The above camera is characterized in that the control part controls an amount of luminescence or directionality of the plurality of light emitters of the emitting part depending on a distance between the camera and the subject.

The above camera is characterized in that light emitted from the emitting part has a wavelength of about 875 nm.

The above camera is characterized in that the emitting part is equipped with a visible light cut filter.

### Advantageous Effects of Invention

Therefore, the present invention can provides an image monitoring system which can be used in a place where a network cannot be established and has excellent portability.

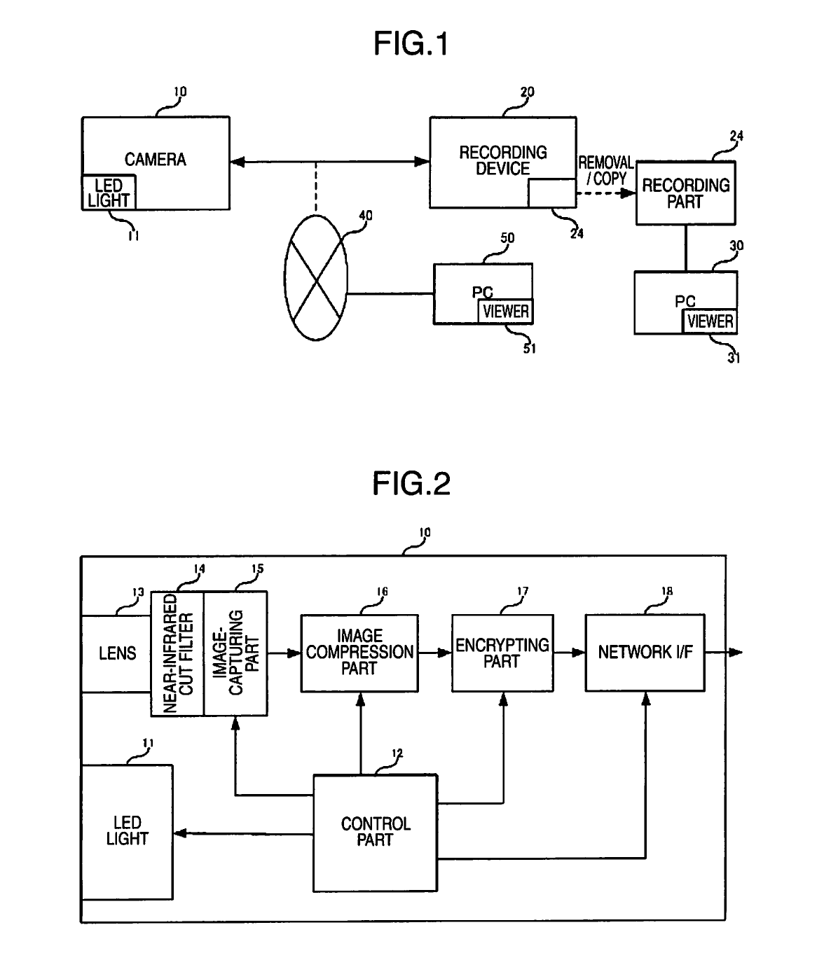

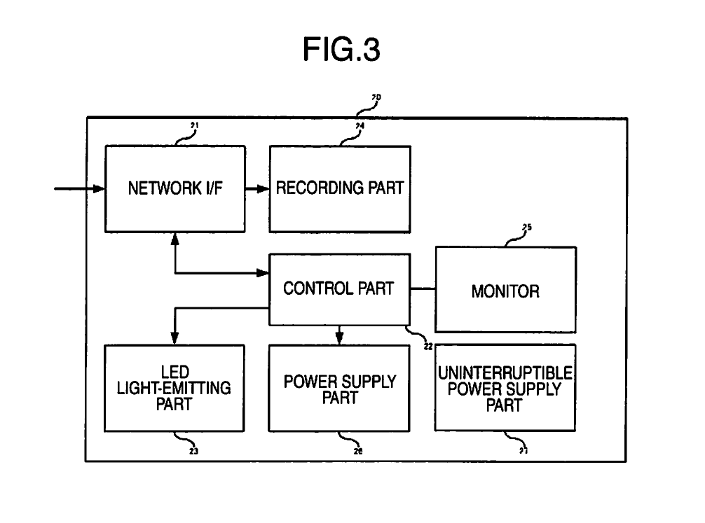

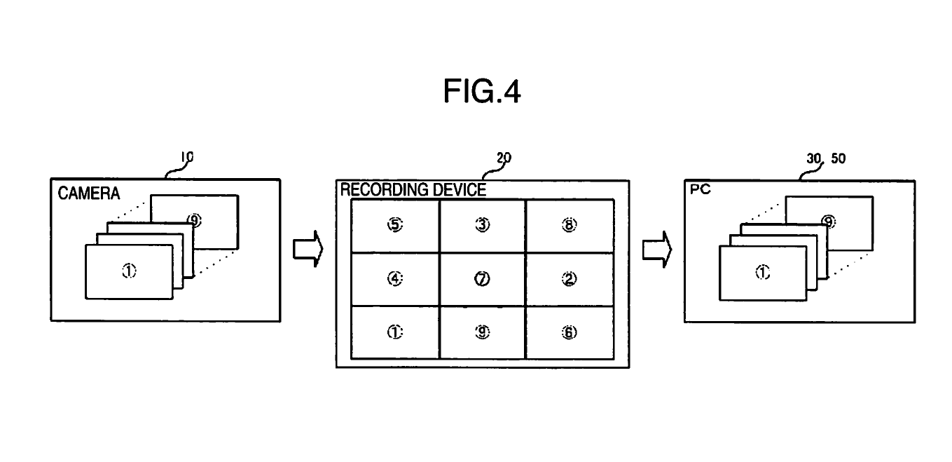

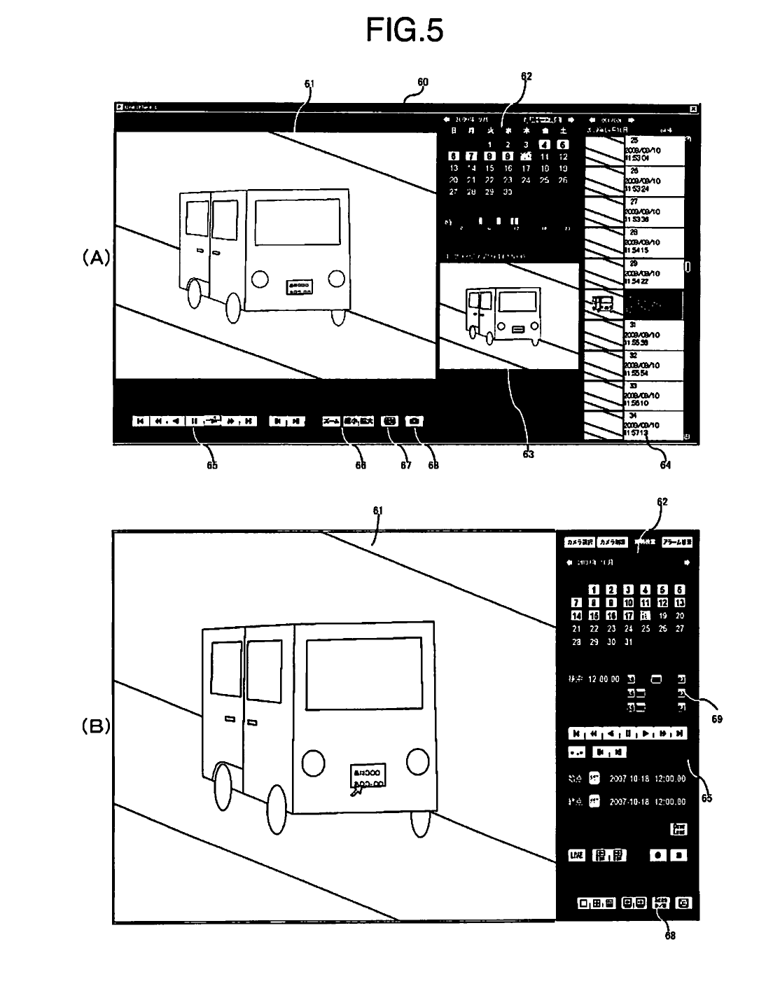

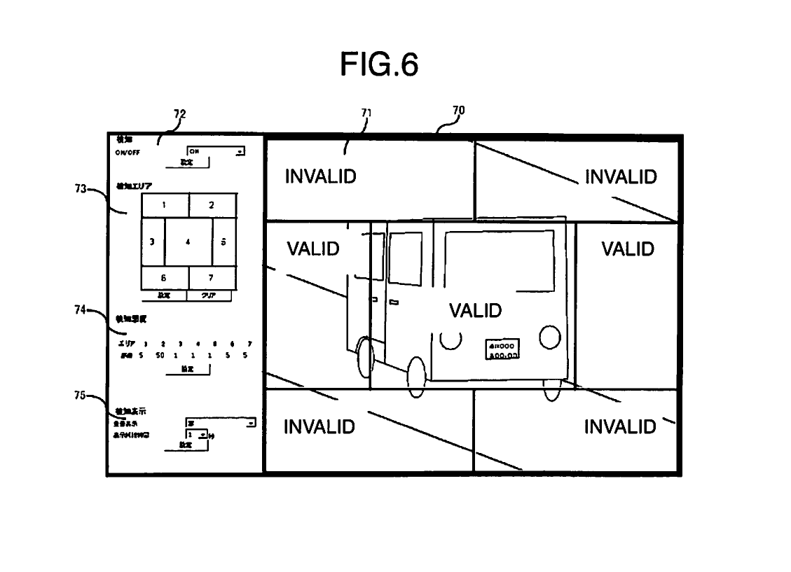

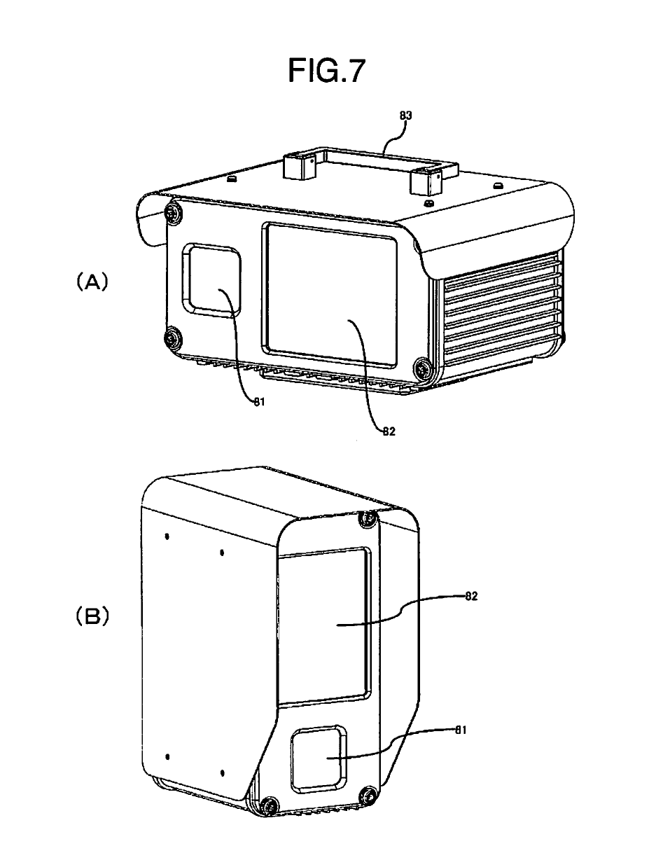

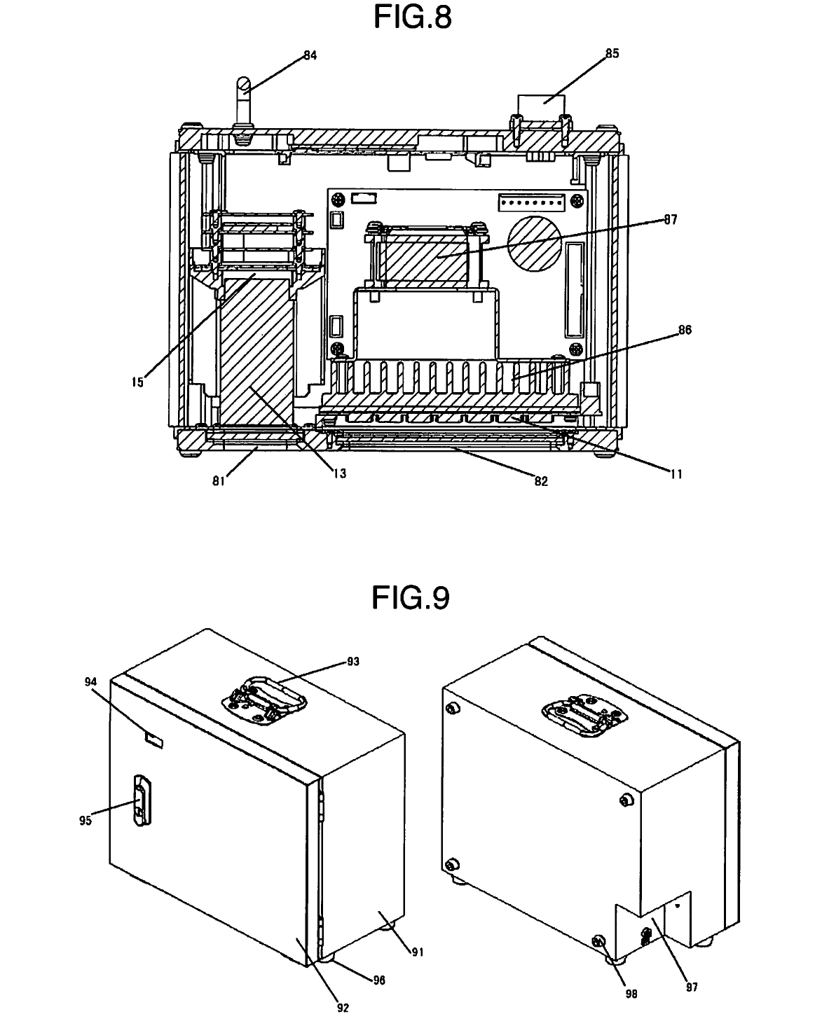

### BRIEF DESCRIPTION OF DRAWINGS

[FIG. 1] A block diagram of a monitoring system according to an embodiment of the invention.

[FIG. 2] An inner block diagram of a camera of the monitoring system according to the embodiment of the invention.

[FIG. 3] An inner block diagram of a recording device of the monitoring system according to the embodiment of the invention.

[FIG. 4] A schematic view showing a state of image encode of the monitoring system according to the embodiment of the invention.

[FIG. 5] An image viewing screen of the monitoring system according to the embodiment of the invention.

[FIG. 6] A moving object detection setting screen of the monitoring system according to the embodiment of the invention.

[FIG. 7] A perspective view of a camera of the monitoring system according to the embodiment of the invention.

[FIG. 8] A sectional view of the camera of the monitoring system according to the embodiment of the invention.

[FIG. 9] A perspective view of a recording device of the monitoring system according to the embodiment of the invention.

[FIG. 10] A block diagram of a conventional monitoring system.

### DESCRIPTION OF EMBODIMENTS

Embodiments of the present invention are described below in detail with reference to the drawings. FIG. 1 is a block diagram of a monitoring system according to an embodiment of the invention.

In FIG. 1, 10 is a camera which captures an image of visible light when used during the daytime or in a bright place and outputs a color image and captures near-infrared light when used during the nighttime or in a dark place, and outputs a monochrome image, 11 is an LED light which emits near-infrared light to a subject when used during the nighttime or in a dark place, 20 is an image recording device which records an image captured by the camera 10, and 24 is a detachable high-capacity recording part such as HDD (Hard disk drive) or SSD (Solid State Drive). Here, the camera 10 is desirably a megapixel camera using an image-capturing part having a large number of effective pixels. The camera 10 is mounted on poles and signs positioned on a street or the like and a terrace or the like of a house with an angle of view adjusted, and the recording device 20 is installed within the reach of the cable. Although the light is described here as an LED, it may be another light source if it can emit near-infrared light.

In a case where an image is captured during the daytime or in a bright place, the camera 10 captures an image of a subject with a near-infrared cut filter attached and outputs a color image. On the other hand, in a case where an image is captured during the nighttime or in a dark place, the near-infrared cut filter is removed from the camera 10, the LED light 11 emits near-infrared light to the subject in synchronization with the shutter speed of the camera 10, and the camera 10 captures an image of near-infrared light reflected from the subject and outputs a monochrome image. The image outputted from the camera 10 is inputted to the recording device through a dedicated cable. Here, the dedicated cable, a communication format and a signal form may be any type, TCP/IP may be used, and a unique protocol may be used. The image recording device 20 receives the image and records in the recording part 24.

As described above, when the image monitoring system is comprised of the camera and the image recording device only, which are directly connected through the dedicated cable, the system can be made minimum, so that there can be provided an image monitoring system which has excellent portability and can be used in a place where a network cannot be established.

In FIGS. 1, 30 and 50 are PC, 31 and 51 are dedicated viewer software, and 40 is a network. By this system, the recorded images can be viewed by removing the recording part 24 and connecting with the PC 30 in which the dedicated viewer software 31 is installed.

When the dedicated cable is divided and connected to the network 40, the images recorded in the recording device 20 can be viewed by means of the PC 50 in which the dedicated viewer software 51 is installed through the network similar to an ordinary network type monitoring system.

FIG. 2 is an inner block diagram of the camera of the monitoring system according to the embodiment of the present invention. 11 is the above-described LED light, 12 is a control part for controlling respective parts of the camera 10, 13 is a lens, 14 is a filter part for attaching/removing a near-infrared cut filter or switching the near-infrared cut filter and the visible light cut filter, 15 is an image-capturing part which receives light which is from the subject and has passed through the lens 13 and the filter part and outputs an image, 16 is an image compression part which compresses the image outputted from the image-capturing part 15 by a predetermined compression format, 17 is an encrypting part for encoding the compressed image by a predetermined mode, and 18 is a network I/F which exchanges a signal with the outside. The near-infrared cut filter switching mechanism may be provided within the lens or provided in front of the image-capturing part independent of the lens.

When an image is captured during the daytime or in a bright place, the control part 12 controls, such that the near-infrared cut filter is inserted at the filter part 14, light which is from the subject is incident through the lens 13, near-infrared light is cut off by the filter part 14, visible light only is incident into the image-capturing part 15, and a color image is outputted.

On the other hand, when an image is captured during the nighttime or in a dark place, the control part 12 controls, such that the near-infrared cut filter is removed from the filter part 14, or the near-infrared cut filter and the visible light cut filter are switched, and the LED light 11 emits near-infrared light to the subject in synchronization with a shutter speed of the image-capturing part 15. Light which is from the subject is incident through the lens 13, the incident light passes through the filter part 14 as it is, or with visible light cut off by the visible light cut filter, to enter into the image-capturing part 15, and a monochrome image is outputted.

The image outputted from the image-capturing part 15 is inputted to the image compression part 16 and subject to image compression according to a compression format such as JPEG (Joint Photographic Experts Group). At this time, if the evidentially of the image is emphasized as the compression format, it is desirable to use a reversible compression format by which data before compression and data having undergone compression/decompression processing, such as PNG (Portable Network Graphics) or GIF (Graphics Interchange Format), become completely equal.

The compressed image is inputted to the encrypting part 17 and encoded by a predetermined format. The encoded image is converted into a signal in a format suitable for the dedicated cable by network I/F and outputted.

Here, the wavelength range of light which is generally called visible light is approximately 360 nm to 830 nm according to the definition of JIS-Z8120, and visible light of a wavelength longer than 620 nm looks red to human eyes. And, the wavelength range of light which is called a near-infrared ray is approximately 700 to 2500 nm and has properties similar to those of visible light. When a light such as an LED emits light of a wavelength having a peak value at, for example, 850 nm which is a near-infrared ray region, light of a wavelength of about ±100 nm is also emitted, and as a result, at least visible light is also emitted at the same time. That is to say, when it is desired to capture an image by emitting without being noticed by, for example, a violating vehicle or the like, red light might be seen, and there is a problem that it is noticed, and an evidence image might not be captured. However, if light of a wavelength having a peak value at 900 nm or 950 nm is emitted, a CCD generally has the best sensitivity at about 700 nm, and after that, the sensitivity worsens as the wavelength becomes longer, so that it is necessary to use light of a wavelength having balanced red light reduction and sensitivity.

Therefore, to obtain a good monochrome image by reducing the red light of the LED light 11 in case of using during the nighttime or in a dark place, there can be considered two methods such as (a) a method of lengthening the wavelength of light emitted from the LED light 11, and (b) a method of removing visible light by inserting a visible light cut filter.

(a) Conventionally, when near-infrared light which is emitted by the near-infrared ray LED light having a peak value at, for example, 850 nm is changed to near-infrared ray LED light having a peak value at, for example, 875 nm, an amount of contained visible light decreases to about 1/4, red light becomes substantially invisible, and 875 nm can be said to be a wavelength for light with balanced red light reduction and sensitivity.

(b) A visible light cut filter is attached to the LED light 11 or a later-described LED light window 82 with the wavelength of the near-infrared light emitted by the LED light 11 unchanged. For example, when the visible light cut filter for removing visible light of a wavelength of 830 nm or less is provided and illumination light having a peak value at 850 nm is emitted, only near-infrared light having a wavelength longer than 830 nm is emitted toward the subject. Thus, visible light is removed when the light emitted from the LED light 11 passes through the visible light cut filter, only the near-infrared light is irradiated to the subject, and the red light becomes substantially invisible.

As described above, when the near-infrared light is irradiated by the method (a) or (b), red light which is visible from the subject is reduced and becomes hardly noticeable by the subject, and a possibility that a good monochrome image can be obtained as an evidence image becomes high.

And, the LED light 11 is provided with plural LEDs and controlled to emit them all together or sequentially. At this time, it is desirable that an amount of luminescence is adjusted depending on a distance from the camera 10 to an image capturing range and to the subject. For example, the LED light 11 is provided with 77 LEDs in all, and three modes L, M and H are set depending on the distance as shown in the following table. In the mode L, 35 LEDs are emitted to illuminate a distance of 10 to 15 m from the camera 10. In the mode M, 49 LEDs are emitted to illuminate a distance of 15 to 20 m from the camera 10. In the mode H, 77 LEDs are emitted to illuminate a distance of 20 to 25 m from the camera 10. Thus, a more flexible system can be installed and used by switching the modes depending on the distance from the camera to the image capturing range and to the subject.

TABLE 1

| Mode | Corresponding distance | LED (Quantity) |
|---|---|---|
| L | 10-15 | 35 |
| M | 15-20 | 49 |
| H | 20-25 | 77 |

Otherwise, the amount of luminescence can be adjusted by controlling the amount of electric power applied to the LED light 11. If an image at a far distance is desired to be captured, electric power can be increased, and if an image at a near distance is desired to be captured, electric power can be decreased.

Otherwise, the irradiation distance can also be adjusted by focusing/spreading the irradiation range of the LED light 11. In such a case, there may be several methods for adjustment of focusing/spreading, and for example, the adjustment can be made by a mechanism that a reflection plate is provided around the LED and the LED position is moved forward and backward.

The above-described modes are strictly one example, the modes may be set to any number, and a corresponding distance and a number of corresponding LEDs can also be determined arbitrarily. And, the irradiation range can also be set arbitrarily.

FIG. 3 is an inner block diagram of the recording device of the monitoring system according to the embodiment of the invention. 21 is a network I/F that exchanges a signal with the outside, 22 is a control part for controlling respective parts of the image recording device 20, 23 is an LED light-emitting part which shows a state of the image recording device 20 in its light emission state, 24 is the above-described recording part, 25 is a detachable monitor for viewing the images recorded in the recording part 24, 26 is a power supply part which converts the inputted AC power into DC power and supplies to each part of the image recording device 20, 27 is a uninterruptible power supply part which supplies power to respective parts or a particular part of the image recording device 20 instead of the power supply part 26 when power supply to the power supply part 26 is cut off.

The network I/F 21 receives the image transmitted from the camera 10 through the dedicated cable, converts the signal form and outputs the image to the recording part 24. The recording part 24 records the received images by composing each plural numbers of them at random under control by the control part 22. This recording method will be described in detail later. To view the recorded images, the monitor 25 is connected to the control part 22, and the dedicated viewer software is used to decompose the composed image for viewing. And, the control part 22 monitors the states of respective parts of the image recording device 20 and controls the LED light-emitting part 23 depending on its state, and the LED light-emitting part 23 emits light depending on the state. For example, here, the indication is made by a color change, lighting, blinking and extinction depending on the on/off state or the remainder capacity of the power source or the remaining recording capacity of the recording part 24. And, the power supply part 26 converts the AC power supplied from the outside into DC power, supplies to each part of the recording device 10, and may supply to the camera 10 through the dedicated cable. In this case, the camera 10 is not required to have a separate external power input part, but the camera 10 may be provided with an external power input part so that it can be operated without power supply from the recording device 20. Incidentally, the power supply part 26 may be a storage battery, a solar power generator or the like. And, if the power 26 fails or the power supply from the outside is cut off, the uninterruptible power supply part 27 may be provided to supply power into the recording device 20 so as to supply to the respective parts but may be made to supply to only a structure for which maintenance is at least necessary. Failure of each apparatus or a loss of the recorded image can be prevented by the uninterruptible power supply part 27.

FIG. 4 is a schematic view showing an image encoding state of the monitoring system according to the embodiment of the invention.

The image obtained by the camera 10 is encoded by previously setting an 8-bit secret key by the encrypting part 17 within the camera 10. The encoded image is compounded at random for every plural pieces within the recording device 20 and recorded as image A in the recording part 24. In this embodiment, for example every nine pieces are sequentially put in random arrangement and composed. And, when viewing on a PC in which the dedicated viewer software is installed, the composed image A is separated to the original nine images, and an 8-bit public key is further inputted to decode so as to display an image. Thus, even if it is tried to view an image on a PC or the like in which the dedicated viewer software is not installed, the image cannot be displayed, and high secrecy can be realized.

FIG. 5 is an image viewing screen of the monitoring system according to the embodiment of the invention. Two screens (A) and (B) are exemplified here but their basic functions are not different. In FIG. 5, 60 is a viewing screen, 61 is an image display part for displaying the image, 62 is a retrieval operation part for retrieving a desired image by designating a date and time, 63 is a selected image display part for showing a selected image, 64 is a retrieved result display part where the image resulting from the retrieval performed according to the conditions inputted by the retrieval operation part 62 is displayed as thumbnails, 65 is playback instruction buttons for performing operations of playback, pause, fast forward, rewind, skip and others, 66 is zoom magnification change buttons for performing operations of zooming in and zooming out of the image, 67 is a detection button for displaying a moving object-detected result, 68 is a snapshot button for storing an image as a snapshot, and 69 is a time advancing button for switching the image displayed on the image display part 61 by adjusting the time in which the image was obtained.

In (A), the retrieval operation part 62 shows a calendar and a time axis, and the background of a date when an image is recorded is colored. When that date is selected, the time having the recorded image is indicated on the time axis, and the recorded image of that date is displayed as thumbnails in chronological order on a retrieved result display part 64. When a desired image is selected from the retrieved result display part 64, the image corresponding to the selected image display part is displayed. The selected recorded image is replayed as a video on the image display part 61. The replayed video can be subject to operations such as playback, pause, fast forward, rewind, skip and others by the playback instruction buttons 65, and a desired position pointed by a zoom magnification ratio change button 66 can be zoomed in or zoomed out. And, the replayed video shows a moving object by framing it by a detection button 67 if the replayed video contains the moving object, and the video of desired timing can be recorded by capturing as a snapshot by a snapshot button 68.

In (B), the retrieval operation part 62 shows a calendar, and the background of a date when an image is recorded is colored. When that date is selected, the recorded image of that date is displayed on the image display part 61 and can be undergone operations such as playback, pause, fast forward, rewind, skip and others as a video by the playback instruction buttons 65. And, when right and left arrows are clicked by a time advancing button 69 or a center selected time indication part is dragged and scrolled, the recorded image of the operated time is displayed on the image display part 61. And, the video of desired timing can be recorded by capturing an image of desired timing as snapshot by the snapshot button 68. In addition, it is also possible to play back by designating the start and end of the date and time desired to be played back.

In both (A) and (B), a live video which is being obtained at present by operations may be displayed on the image display part 61.

FIG. 6 is a moving object detection setting screen of the monitoring system according to the embodiment of the invention. In FIG. 6, 70 is a moving object detection setting screen, 71 is an image display part, 72 is a detection ON/OFF setting part for switching on/off of moving object detection, 73 is a detection area setting part for setting an moving object detection area, 74 is a detection sensitivity setting part for setting detection sensitivity of each area determined by the detection area setting part 73, and 75 is a detection display setting part for setting a display method of the moving object detection result.

In the detection ON/OFF setting part 72, “ON” or “OFF” is pulled down to select whether or not the moving object detection is performed, and the setting button is pushed down to apply conditions. The detection area setting part 73 sets the image area to a desired range, and detection validity/invalidity is set for each area. In addition, the set area and the detection validity/invalidity of each area are displayed on the image display part 71. In this embodiment, the area is divided and set to seven, but the area may be set to any numbers, and its size may be changed in various ways. The detection sensitivity setting part 74 sets detection sensitivity of the moving object detection area set by the detection area setting part 73. In the detection display setting part 75, a superimposed display method and a display continuation time for the image in the detection area are selected by pulling down, and the setting button is pushed down to apply conditions.

The recording method may be continuous recording to keep recording always, recording in association with the moving object detection, or recording at a low frame rate normally but at a high recording rate at the time of the moving object detection.

FIG. 7 is a perspective view of a camera of the monitoring system according to the embodiment of the invention. (A) is a camera with the camera part (lens and image-capturing part) and the LED light arranged horizontally, and (B) is a camera with the camera and the LED light arranged vertically. In FIG. 7, 81 is a camera window through which light is taken into the lens 13 within the camera 10, 82 is an LED light window 82 through which light emitted from the LED light 11 within the camera 10 passes, and 83 is a grip part used to carry the camera 10.

The camera 10 is provided with a sunshade cover for covering from the top to the side surfaces so that unnecessary light (direct light from the sun, or illumination light of street lamps or the like) enters through the camera window 81. And, the right and left side surfaces and the bottom surface of the camera 10 are provided with radiation fins, and heat generated within it can be radiated efficiently. And, the grip part 83 is provided on the ceiling surface of the camera 10, and it is convenient for carrying.

Incidentally, heater glass may be used for the camera window 81 and the LED light window 82 for prevention of dew condensation, and the LED light window 82 may be fitted with a visible light cut filter.

FIG. 8 is a horizontal sectional view of the camera of the monitoring system according to the embodiment of the invention. In FIG. 8, 84 is a grip part for opening the door on the back surface, 85 is a connector part for connecting a cable for exchanging signals and electric power with the outside of the camera 10, 86 is a radiation fin for radiation of heat of a substrate on which the LEDs are provided, and 87 is a fan for blowing air toward the radiation fin 86.

Since the camera 10 has a sealed structure, its inside is easily filled with heat. Therefore, the radiation fin 86 is attached to the back side of the substrate on which the LEDs with especially large generation of heat are mounted and blows air to the radiation fin 86 by the fan 87 to enhance heat radiation effect. The blown air hits the radiation fin 86 to absorb heat, flows in vertical directions within the camera 10, further flows backwards, and is absorbed into the fan again and exhausted so as to be circulated. At this time, air having heat circulates while conducting heat to the inside wall surface of the camera 10, so that it is cooled, and the heat conducted to the wall surface of the camera 10 is radiated outside. At this time, heat radiation can be made with high efficiency because the radiation fin is provided on the outside wall surface of the camera 10.

Incidentally, the inside structure of the camera 10 corresponds to both of the (A) and (B) of FIG. 7.

FIG. 9 is a perspective view of the recording device of the monitoring system according to the embodiment of the invention. In FIG. 9, 91 is a recording device housing, 92 is a door part for opening and closing the recording device housing, 93 is a grip part which is grasped to carry the recording device 20, 94 is an LED display window through which the LED light-emitting part 23 can be looked, 95 is a lock part so that no body can open it when the door part 92 is closed, 96 is leg parts for supporting the recording device 20 when the recording device 20 is placed upright, 97 is a connector part for connecting a cable for exchanging signals and electric power with the outside of the recording device 20, and 98 is leg parts for supporting the recording device 20 when the recording device 20 is laid down.

The recording device housing 91 and the door part 92 are mutually coupled at one end by means of hinges or the like, the door part 92 is closed airtight by pivoting with the coupled end as an axis. In addition, when the lock part 95 is activated with a key, the recording device 20 can never be opened by another person. The grip part 93 is provided on the ceiling surface of the recording device 20, and it is convenient for carrying.

The housings for the camera 10 and the recording device 20 are formed of, for example, aluminum, stainless steel, a copper material, plastic or the like.

In the above description on the monitoring system, the effects were described in part assuming the camera and the image recording device, but it is also possible to use for an ordinary camera or the like other than the day/night camera which switches the infrared ray cut filter, and various changes in its structure and operation and the contents thereof may also be made for implementation without departing from the gist of the invention.

In short, the present invention is not limited to the above-described embodiments as they are, but in an operation stage, component elements can be materialized by modifying them in the range not deviating from the gist. And, various inventions can be made by appropriate combination of the plural component elements disclosed in the above-described respective embodiments. For example, some component elements may be deleted from all component elements described in the respective embodiments. In addition, the component elements of different embodiments may be combined appropriately.

### INDUSTRIAL APPLICABILITY

An image monitoring system which can be used in a place where a network cannot be established, has excellent portability and obtains a monitoring image regardless of day, night, bright and dark is provided.

### REFERENCE SIGNS LIST

10: Camera, 11: LED light, 12: control part, 13: lens, 14: filter part, 15: image-capturing part, 16: image compression part, 17: encrypting part, 18: network I/F, 20: recording device, 21: network I/F, 22: control part, 23: LED light-emitting part, 24: recording part, 25: monitor, 26: power, 27: uninterruptible power supply part, 30: PC, 31: viewer software, 40: network, 50: PC, 51: viewer software, 60: viewing screen, 61: image display part, 62: retrieval operation part, 63: selected image display part, 64: retrieved result display part, 65: playback instruction buttons, 66: zoom magnification ratio change button, 67: detection button, 68: snapshot button, 69: time advancing button, 70: moving object detection setting screen, 71: image display part, 72: detection ON/OFF setting part, 73: detection area setting part, 74: detection sensitivity setting part, 75: detection display setting part, 81: camera window, 82: LED light window, 83: grip part, 84: grip part, 85: connector part, 86: radiation fin, 87: fan, 91: recording device housing, 92: door part, 93: grip part, 94: LED display window, 95: lock part, 96: leg parts, 97: connector part, 98: leg parts.

1. An image monitoring system, comprising:
a camera which is provided with an image-capturing part for capturing an image of a subject and outputting the image, an encrypting part for encoding the image and a control part for controlling the image-capturing part and the encrypting part, and
a recording device which is provided with a detachable recording medium for recording the image captured by the camera and a control part for controlling the recording medium, wherein:
the camera and the recording device are connected via a cable.

2. The image monitoring system according to claim 1, wherein:
the obtained images are encoded by means of a secret key in the encrypting part of the camera, and
the recording device records a single file that plural images were unified.

3. A camera, comprising:
an image-capturing part for capturing an image of a subject and outputting the image,
a filter part for attaching/removing an infrared ray cut filter,
an emitting part which has a plurality of light emitters and emits near-infrared light, and
a control part for controlling the image-capturing part, the filter part and the emitting part, wherein:
the control part controls to obtain an image with the infrared ray cut filter inserted when it is bright, and controls to remove the infrared ray cut filter when it is dark and to make the emitting part emit in synchronization with the shutter timing of the image-capturing part.

4. The camera according to claim 3, wherein:
the control part controls an amount of luminescence or directionality of the plurality of light emitters of the emitting part depending on a distance between the camera and the subject.

5. The camera according to claim 3, wherein:
light emitted from the emitting part has a wavelength of about 875 nm.

6. The camera according to claim 3, wherein:
the emitting part is equipped with a visible light cut filter.
